(19) United States
(12) Patent Application Publication
(10) Pub. No.: US 2025/0102100 A1
(43) Pub. Date: Mar. 27, 2025

(54) METHOD AND SYSTEM FOR MAPPING AND/OR INSPECTING A PIPELINE INFRASTRUCTURE

(71) Applicant: REDUCT NV, Schelle (BE)

(72) Inventors: Hans Van Nieuwenhuyze, Wilrijk (BE); Daan Tamsyn, Londerzeel (BE); Otto Ballintijn, Schilde (BE)

(73) Assignee: REDUCT NV, Schelle (BE)

(21) Appl. No.: 18/728,186

(22) PCT Filed: Jan. 14, 2022
(86) PCT No.: PCT/EP2022/050806

§ 371 Date: Jul. 11, 2024

(51) Int. Cl. F16L 55/40; F16L 55/30; F16L 55/48; F16L 101/30

(52) U.S. Cl. CPC F16L 55/40; F16L 55/30; F16L 55/48; F16L 2101/30

(57) ABSTRACT

System and method for mapping and/or inspecting an underground pipeline infrastructure. The system comprises a sensor probe for collecting geospatial data while travelling through a pipeline of the pipeline infrastructure, and a driving mechanism for driving the sensor probe. The sensor probe comprises a train of at least two modules of which a first module contains a sensor pay load for collecting said geospatial data and a second module is provided for connecting the sensor probe to the driving mechanism, wherein successive modules of said train are connected to each other by means of a flexible connection which allows the sensor probe to travel through pipeline bends, wherein each flexible connection comprises a spring configured for straightening the sensor probe and a flexible element mounted on the inside of the spring configured for bearing a predefined tensile load.

### TECHNICAL FIELD

The present invention relates to methods and systems for mapping and/or inspecting pipeline infrastructures, such as for example an underground fluid pipeline.

### BACKGROUND ART

The underground natural gas utility infrastructure is vast and expansive. These systems can span thousands of kilometers underneath the ground and are very challenging to inspect and map. Often, records are kept with low accuracy positioning data or stored via paper facilitating a need to collect highly accurate and digital location data. Some solutions can map pipelines from the surface, but lack verification that the mapped conduit is that actual asset. Soil conditions, pipe wall material, or adjacent underground facilities can negatively impact this location data. There are efforts to create in-line robots or pigs that combine pipeline inspection and mapping, but these devices typically work in pipes greater than 30 cm in diameter. These devices also typically require expensive launching and retrieving equipment.

Current technologies are generally applied to only “out-of-service” pipelines and not to “live” pipelines, the latter meaning that the inspection and/or mapping occurs while the pipelines are in use for supplying a fluid, such as natural gas.

More in general, there is a continuing need for improved systems and methods for mapping and/or inspecting pipeline infrastructures.

Some methods and systems for mapping pipeline infrastructures are known from WO2004048892A1 and WO2004048893A1.

### DISCLOSURE OF THE INVENTION

It is an aim of the present invention to provide improved systems and methods for mapping and/or inspecting pipeline infrastructures, such as for example an underground fluid pipeline.

This aim is achieved according to the invention with a system and a method showing the technical characteristics of the independent claims.

In an aspect, which may be combined with other aspects and/or embodiments described herein, the invention relates to a system for mapping and/or inspecting an underground pipeline infrastructure, comprising: a sensor probe for collecting at least geospatial data while travelling through a pipeline of the pipeline infrastructure, and a driving mechanism for driving the sensor probe. The sensor probe may comprise a train of at least two modules of which a first module contains a sensor payload for collecting said geospatial data and a second module is provided for connecting the sensor probe to the driving mechanism. In embodiments, each two successive modules of said train may be connected to each other by means of a flexible connection which allows the sensor probe to travel through pipeline bends, wherein each flexible connection may comprise a spring configured for straightening the sensor probe and a flexible element mounted on the inside of the spring configured for bearing a predefined tensile load.

It has been found that connecting the modules by means of such a flexible connection, preferably comprising a spring and a flexible element such as a chain inside the spring, the flexibility of the sensor probe, in particular its capacity to take sharper turns and/or to be bent to a greater extent, can be enhanced while still ensuring that the sensor probe returns to its original, natural state after the bend in the pipeline and while still achieving a robust sensor probe capable of withstanding a predefined tensile load. Embodiments of the sensor probe according to the invention may be capable of taking a sharp 90° turn and, for example be entered into a live pipeline at a perpendicular angle through a live-fluid entry apparatus and make a 90° angle change of direction once inside the pipeline to align with the orientation of the pipeline. The tensile load-bearing capacity may be of particular importance when the sensor probe is to be pulled back through the pipeline infrastructure. The capability of straightening the sensor probe after each turn may have advantages in enhancing the accuracy of data collected by means of the sensor payload.

In embodiments, the spring(s), or at least one of them, may be further configured for removing torsion from the sensor probe. This means that the spring(s) may be connected to the modules in such a way that any torsion which occurs upon driving the sensor probe through the pipeline is counteracted by the spring(s). This may for example be achieved by providing the spring with bent front and rear ends which fit into notches provided in the respective modules in front of and behind the spring. The removal of torsion may have advantages in enhancing the accuracy of data collected by means of the sensor payload.

In embodiments, the spring(s), or at least one of them, may be further configured for maintaining the flexible element inside the spring at maximum length. This means that the spring(s) may be held between the modules in their natural state, or in a slightly compressed state, in general preferably at least such that the spring force tends to stretch the flexible element to its maximum length. This may enhance the capability of straightening the sensor probe after each turn, which may have advantages in further enhancing the accuracy of data collected by means of the sensor payload.

In embodiments, the sensor probe may be generally circular in cross-section with a first outer diameter, which is the maximum diameter along the sensor probe. Preferably, the first outer diameter is in a range of 25 to 40 mm, more preferably in a range of 30 to 35 mm. Each spring may have a second outer diameter with the second outer diameter being smaller than the first diameter, preferably between 50 and 90% of the first diameter, more preferably between 60 to 80% of the first diameter. Preferably, each of the modules have substantially the same, first, outer diameter. Preferably, each of the springs have substantially the same, second, outer diameter. The smaller diameter along the springs may have advantages in further enhancing the flexibility of the sensor probe.

In embodiments, the spring(s), or at least one of them, may have, a plurality of coils. Preferably, each spring has, its natural state, front and rear sections where the coils of the spring are spaced apart and a middle section where the coils lie against each other. In this way, the front and rear sections of the spring can expand on the outside of a bend and contract on the inside of the bend, which may have advantages in further enhancing the flexibility of the sensor probe.

In embodiments, the tensile load-bearing flexible element(s), or at least one of them, preferably have a tensile strength (minimum breaking strength) in a range between 0.3 kN and 1.5 kN, more preferably between 0.4 kN and 1.3 kN, more preferably between 0.5 kN and 1.0 kN. In embodiments, the tensile load-bearing flexible element(s), or at least one of them, may be a chain, preferably with a chain grade of at least 30. In embodiments, the tensile load-bearing flexible element(s), or at least one of them, may also be a rope or cable or the like, such as for example a twisted steel wire rope.

In embodiments, the chain(s), or at least one of them, may have at least three, preferably at least four pivot points and/or at least two, preferably at least three complete chain links, in order to achieve an improved flexibility of the sensor probe and/or ensure its capacity of taking a sharp 90° turn.

In another aspect, which may be combined with other aspects and/or embodiments described herein, the invention relates to a system for mapping and/or inspecting an underground pipeline infrastructure, comprising a sensor probe with a train of modules, wherein each two successive modules of said train are connected to each other by means of a flexible connection which allows the sensor probe to travel through pipeline bends, and wherein the train of modules comprises at least one of the following: a first module containing a sensor payload for collecting geospatial data, a second module provided for connecting the sensor probe to a driving mechanism, a third module containing a communication and/or power interface for transferring the collected data to an external computer system and/or for charging a battery of the probe, a fourth module containing an electromagnetic field generator for locating the sensor probe in combination with an external locating device and thereby determining at least one location coordinate, a fifth module comprising a visual inspection device such as a camera, a sixth module comprising an odometer for recording a path travelled by the sensor probe as it is driven through the pipeline, a seventh module comprising at least one environment sensor for measuring for example pressure, temperature, humidity or another environment parameter.

It has been found that by dividing the sensor probe into a train of modules, each with a different functionality and being interconnected by means of the flexible connection(s), a flexible, modular system of modules for a sensor probe can be achieved which is highly flexible can be easily adapted to a particular measurement situation. Due to the compartmentalization into modules, the flexibility of the sensor probe, in particular its capacity to take sharper turns and/or to be bent to a greater extent, can be enhanced. Embodiments of the sensor probe according to the invention may be capable of taking a sharp 90° turn and, for example be entered into a live pipeline at a perpendicular angle through a live-fluid entry apparatus and make a 90° angle change of direction once inside the pipeline to align with the orientation of the pipeline.

In embodiments, the sensor probe, preferably each of the modules, has an aerodynamic shape for reducing interference with a fluid in the pipeline.

In embodiments, the first module containing the sensor payload may be the front module of the train. The second module provided for connecting the sensor probe to the driving mechanism may be the rear module of the train.

In embodiments, the driving mechanism may comprise a tether, such as for example a fiber rod, for pushing the sensor probe through the pipeline infrastructure. An odometer may be incorporated into one of the modules of the sensor probe. Alternatively, the system may comprise an odometer in combination with the tether for recording a path travelled by the sensor probe as it is driven through the pipeline, preferably wherein the odometer is provided to record the length of the tether that passes along the odometer.

In embodiments, the first module containing the sensor payload, or generally the front module, may be larger and heavier than the subsequent modules of the train. For example, the front module may have an oblong shape while subsequent modules may have a substantially spherical shape. In this way, it may be achieved that the first or front module remains in a more central position on the bottom of the pipeline with respect to the other modules. In other words, it may be achieved that the sensor probe better follows the shape of the pipeline through which it is driven. This may increase the accuracy of the data collected by means of the sensor probe.

In another aspect, which may be combined with other aspects and/or embodiments described herein, the invention relates to a method for mapping and/or inspecting an underground pipeline infrastructure, comprising: entering a sensor probe according to any embodiment as described herein into a pipeline of the pipeline infrastructure, driving the sensor probe through the pipeline by means of a driving mechanism, and collecting geospatial data by means of the sensor probe while it travels through the pipeline.

In embodiments, the sensor probe may be pushed through the pipeline by means of a tether of the driving mechanism, such as for example a fiber rod, wherein the tether causes the sensor probe to roll as it is pushed through the pipeline, and wherein a roll value of the sensor probe is recorded by means of the sensor payload in the first module.

In embodiments, the first module may be larger and heavier than the subsequent modules of the train, such that the first module remains in a more central position on the bottom of the pipeline with respect to the other modules. This may increase the accuracy of the data collected by means of the sensor probe, especially in combination with the measurement or determination of the roll value by means of one or more sensors of the sensor payload.

In embodiments, the method may further comprise recording a path travelled by the sensor probe as it is driven through the pipeline by means of an odometer, preferably wherein the odometer is external to the sensor probe and records the length of the tether that passes along the odometer.

In embodiments, the method may further comprise determining at least one location coordinate, such as a start-point coordinate, an end-point coordinate and/or a guide-point coordinate of the sensor probe by means of an electromagnetic field generator provided in one of the modules of the sensor probe in combination with an external locating device.

In embodiments, the sensor probe may be used to collect the geospatial data in at least one of a forwards travelling direction (wherein the sensor probe is for example pushed by means of the tether) and a backwards travelling direction (wherein the sensor probe is for example pulled back by means of the tether).

In another aspect, which may be combined with other aspects and/or embodiments described herein, the invention relates to a non-transitory storage medium storing a real-time or post-processing software which is configured to, when executed on a computer system, merge geospatial data collected by means of the sensor probe as defined in any one of the preceding claims, a path travelled by the sensor probe recorded by means of an odometer, and at least one location coordinate determined by means of the sensor probe in combination with an external locating device.

### BRIEF DESCRIPTION OF THE DRAWINGS

The invention will be further elucidated by means of the following description and the appended figures.

FIG. 1 shows a schematic overview of an embodiment of a system according to the invention.

FIG. 2 shows a perspective view of an embodiment of a sensor probe of a system according to the invention.

FIGS. 3, 4 and 5 respectively show a perspective view, an exploded view and a cross-sectional view of another embodiment of a sensor probe of a system according to the invention.

FIGS. 6 and 7 show details of the embodiment of FIGS. 3-5.

FIG. 8 shows a cross-sectional view of the embodiment of FIGS. 3-5 when taking a 90° turn.

### MODES FOR CARRYING OUT THE INVENTION

The present invention will be described with respect to particular embodiments and with reference to certain drawings but the invention is not limited thereto but only by the claims. The drawings described are only schematic and are non-limiting. In the drawings, the size of some of the elements may be exaggerated and not drawn on scale for illustrative purposes. The dimensions and the relative dimensions do not necessarily correspond to actual reductions to practice of the invention.

Furthermore, the terms first, second, third and the like in the description and in the claims, are used for distinguishing between similar elements and not necessarily for describing a sequential or chronological order. The terms are interchangeable under appropriate circumstances and the embodiments of the invention can operate in other sequences than described or illustrated herein.

Moreover, the terms top, bottom, over, under and the like in the description and the claims are used for descriptive purposes and not necessarily for describing relative positions. The terms so used are interchangeable under appropriate circumstances and the embodiments of the invention described herein can operate in other orientations than described or illustrated herein.

Furthermore, the various embodiments, although referred to as “preferred” are to be construed as exemplary manners in which the invention may be implemented rather than as limiting the scope of the invention.

The term “comprising”, used in the claims, should not be interpreted as being restricted to the elements or steps listed thereafter; it does not exclude other elements or steps. It needs to be interpreted as specifying the presence of the stated features, integers, steps or components as referred to, but does not preclude the presence or addition of one or more other features, integers, steps or components, or groups thereof. Thus, the scope of the expression “a device comprising A and B” should not be limited to devices consisting only of components A and B, rather with respect to the present invention, the only enumerated components of the device are A and B, and further the claim should be interpreted as including equivalents of those components.

### Sensor Payload

As used herein, with “geospatial data” is intended x, y, and z geospatial data or sensor data from which such x, y, and z geospatial data may be determined. The sensor probe may generally be any data collecting device which is used for measuring data relating to at least the trajectory of a pipeline infrastructure, by being driven through the pipeline infrastructure. The sensor payload (not shown in the drawings) of the probe may comprise a set of onboard sensors, e.g. MEMS-sensors, enabling the sample wise collection of physical measurement data during the movement of the sensor probe and enabling the determination of a heading profile, a pitch profile, a distance and/or acceleration profile and a roll profile from the collected measurement data. In order to ensure that these profiles can be determined with sufficient accuracy, the onboard sensors of the device may be synchronised to a common clock signal. During the movement of the sensor probe from the start location to the end location of the trajectory, the measurement data may be stored, preferably in a memory of the sensor probe, for evaluation later on. Before the evaluation of the collected measurement data for determining the profiles and a track from the profiles, an error compensation may be applied to measurement data of at least a first and a second sensor of the device. In other words, an error compensation may be already applied on the level of sensor data, before any of these data are used for calculating profiles for roll, pitch, distance, acceleration or heading. As a result, the accuracy of the track which is finally obtained from the compensated measurement data can be improved.

The error compensation which is applied on the level of the measurement data may be determined by correlating the measurement data of at least first and second sensors of the sensor payload with each other. These sensors may be different sensors in the sense that they measure different physical quantities, such as for example a speed and an acceleration or other. The correlation may be performed by determining trajectory parameters by using each time the data of each sensor, i.e. by converting the measurement data to parameters relating to a common physical quantity, and mapping the trajectory parameters obtained from the data of the first sensor on the trajectory parameters obtained from the data of the second sensor. This means that measurement data of the first and second sensors may be converted to trajectory parameters for enabling a comparison between the two, so that deviations in the measurement data of the first sensor can be evaluated by means of the trajectory parameters of the second sensor and vice versa.

An example of measurement data level error compensation which may be used in embodiments of the method of the invention, is correlating the measurement data of a first sensor for measuring the gravitational force in a vertical plane of the device and a second sensor for measuring the angle variation around the longitudinal direction of the device. In this case, a roll position of the sensor probe is obtainable from both the first and the second sensor, more particularly by integration over the measurement data of the second sensor and directly from the measurement data of the first sensor.

The integrated measurement data of the first sensor constitute first trajectory parameters for the roll position and the measurement data of the second sensor constitute second trajectory parameters for the roll position. In previous measurements, it may have been determined how the first and second trajectory parameters are to be interpreted in relation to each other for detecting deviations for both sensors. These deviations in the trajectory parameters may then be converted back to data deviations, which form the error compensation to be applied on the measurement data of each sensor. This error compensation may then be applied to the measurement data of both sensors, before the roll profile of the data collecting device is determined on the basis of the corrected measurement data of both sensors.

Due to the error compensation on the level of measurement data, the accuracy of the pitch, heading, roll and distance and/or acceleration profiles which are determined on the basis of the corrected measurement data can be enhanced. Consequently, the data collecting device can be allowed to move independently along the trajectory and can be applied for obtaining geographical data of a variety of pipeline trajectories, such as for example utility ducts, onshore and offshore pipelines or the like, vertical or horizontal boreholes or other trajectories.

Further features of the sensor payload and the manner in which the trajectory is determined from the collected data are described in WO2004048892A1 and WO2004048893A1 by the same applicant, which are incorporated herein by reference in their entirety.

### System Overview

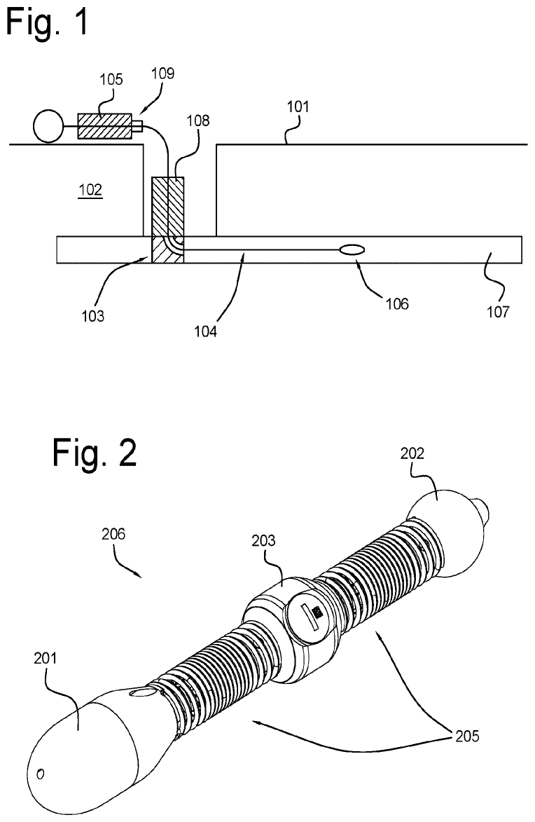

FIG. 1 shows a system according to one embodiment of this invention, and a method of use, for entering a live fluid pipe with a sensor payload 106 to map and/or inspect the pipe. A section of live fluid pipe 107 is excavated by making a hole in the ground 102 above, to reveal an insertion point. Live fluid pipe 107 can be any means of housing or conveying utilities. The sensor payload 106 can enter at an upright 90-degree angle via live entry apparatus 108 to enable two-way travel.

Live-fluid entry apparatus 108 can be, for example, a Jameson™ directional entry tool. Sensor payload 106 is attached to tether 104. The sensor payload 106 can be or include any suitable sensor, as described herein. Tether 104 can be a flexible fiberglass rod with or without an integrated tracer wire for surface location, or can be a Condux™ push rod, optionally supplemented by an electric, hand-driven, or pneumatic pushing solution. Tether 104 can also supply power and two-way data communication to the sensor payload 106. Tether 104 is pushed through external odometer 109, which may be provided above the surface 101 as shown. The external odometer 109 records the pipe length (distance travelled by the sensor payload 106). This is fused with sensor payload 106 data and a start coordinate, and a second coordinate, to provide x, y, and z position data with accompanying sensor analysis along the trajectory of the live fluid pipe. Optionally this could be fused with sensor travel duration data. Propulsion is enabled by conveying tether 104 via external driving force 105, which can be provided by manual force by an operator or a system of motors. Sensor payload 106 is guided by launch shoe 103 in the direction of choice. While driving the sensor payload, x, y, and z positional data can be collected from the MEMS-sensors while features are recorded by the sensor analyzer system. Feature data and x, y, and z data can be post-processed or viewed in real-time to locate features and abnormalities so that underground pipeline owners can obtain accurate maps of their systems with internal inspection data through one internal mapping and inspection system.

Embodiments according to the invention further include other pipeline infrastructures, i.e. also pipeline infrastructures which are not used for transporting fluids, such as for example infrastructures for electric or communication cables, or other.

In embodiments according to the invention, the tether may comprise at least one of the following: an integrated tracer wire, a two-way data communication line, a power feed. In embodiments according to the invention, other driving or propulsion mechanisms may also be used for driving the sensor probe through the pipeline infrastructure.

### Sensor Probe

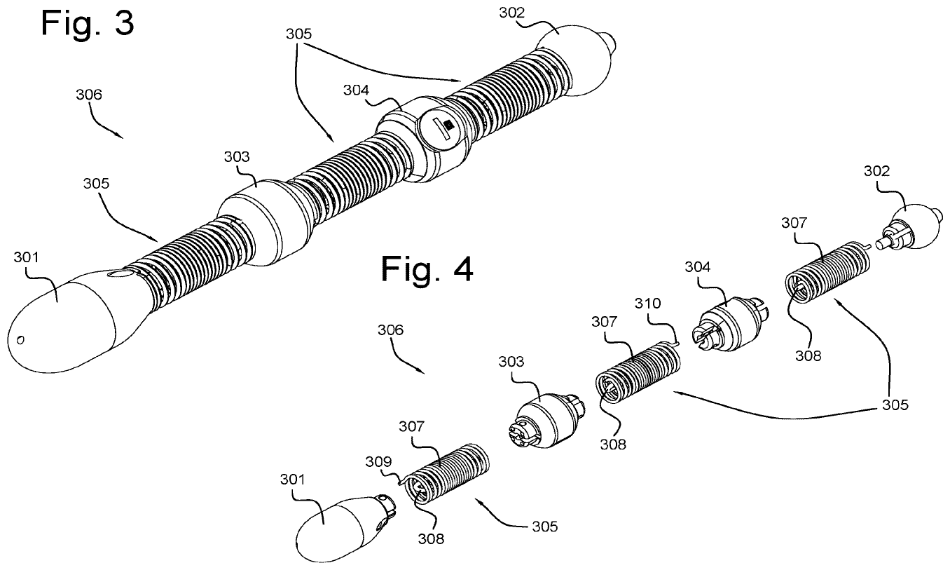

Embodiments according to the invention comprise a sensor probe, such as for example shown in FIGS. 2 and 3-5. The sensor probe 206, 306 may comprise a train of at least two modules 201-203, 301-304. Preferably a first module, preferably the front module 201, 301, contains the sensor payload for collecting at least the geospatial data. Preferably a second module, preferably the rear module 202, 302, is provided for connecting the sensor probe to the driving mechanism, for example a tether such as a fiber rod 104 for pushing and/or pulling the sensor probe through the pipeline 107.

Each two successive modules of the train may be connected to each other by means of a flexible connection 205, 305 which allows the sensor probe to travel through pipeline bends, wherein each flexible connection may comprise a spring 307 configured for straightening the sensor probe and a (non-stretchable) flexible element, for example a chain 308 or a rope or cable or the like, mounted on the inside of the spring configured for bearing a predefined tensile load.

In embodiments described herein, the train of modules comprises at least one of the following: a first module 201, 301 containing the sensor payload for collecting geospatial data, a second module 202, 302 provided for connecting the sensor probe to the driving mechanism, a third module 303 containing a communication and/or power interface for transferring the collected data to an external computer system and/or charging a battery of the sensor payload, a fourth module 203, 304 containing an electromagnetic field generator for locating the sensor probe in combination with an external locating device and thereby determining at least one location coordinate, a fifth module (not shown) comprising a visual inspection device such as a camera, a sixth module (not shown) comprising an odometer for recording a path travelled by the sensor probe as it is driven through the pipeline, a seventh module (not shown) comprising at least one environment sensor for measuring for example pressure, temperature, humidity or another environment parameter.

It has been found that by dividing the sensor probe 206, 306 into a train of modules 201-203, 301-304, each with a different functionality and being interconnected by means of the flexible connection(s) 205, 305, a flexible, modular system of modules for a sensor probe can be achieved which is highly flexible and can be easily adapted to a particular measurement situation. For example, means may be provided for easy removal or addition of a module from or to the train. In the embodiments shown, the removal of a module may be done by compressing the spring 307 to reveal the connection of the chain 308 inside and subsequently disconnecting the chain from the respective module. In other embodiments, this could be achieved by making in each module a removable portion, for example a portion of the housing to which a spring and chain are connected and which can be unscrewed from the remainder of the housing. For example, the module containing the electromagnetic field generator may be removed if location coordinates, such as a start-point coordinate of the trajectory of the pipeline, an end-point coordinate and/or a guide-point coordinate, can be measured separately, i.e. without involving the sensor probe. As another example, a module similar to those shown in the drawings and comprising an odometer may be added if it is desired to measure the path travelled by the sensor probe by means of the sensor probe itself. As another example, a module similar to those shown in the drawings and comprising visual inspection means such as one or more cameras may be added if visual inspection of the inside of the pipeline is desired. As another example, a module similar to those shown in the drawings may be added which comprises at least one environment sensor for measuring for example pressure, temperature, humidity or another environment parameter.

Due to the compartmentalization into modules, the flexibility of the sensor probe, in particular its capacity to take sharper turns and/or to be bent to a greater extent, can be enhanced. Embodiments of the sensor probe according to the invention may be capable of taking a sharp 90° turn and, for example be entered into a live pipeline at a perpendicular angle through a live-fluid entry apparatus and make a 90° angle change of direction once inside the pipeline to align with the orientation of the pipeline, as schematically shown in FIG. 1.

In the embodiment shown in FIG. 2, the front module 201 contains the sensor payload and the communication and power interface for transferring the collected data to an external computer system and charging a battery of the sensor payload. To this end, a portion of the housing of the front module may be removable in order to access the communication and power interface, after the sensor probe has been retrieved from the pipeline. The rear module 202 is provided for the connection to the driving mechanism and contains an opening at the rear end of the probe for receiving an end of a tether such as a fiber rod. A middle module 203 contains the electromagnetic field generator for locating the sensor probe in combination with an external locating device.

The housing of the front module 201 is preferably made of a metal or an alloy, such as for example steel, in order to obtain an increased mass in view of keeping the sensor payload centered in the pipeline and/or counteracting vibrations introduced while pushing and/or pulling the probe, and in view of shielding the electronics of the sensor payload (not shown) from electromagnetic interference. In this manner, the sensor payload can be deployed in all pipe materials, including PE, steel and PVC, as well as near live power cables and other sources of electromagnetic interference that typically have a negative impact on the accuracy of other mapping methods.

The housing of the middle module 203 is preferably made of a plastic material, or in general a material which does not block the electromagnetic field generated by the electromagnetic field generator for the purposes of locating the sensor probe in combination with the external locating device.

The housing of the rear module 202 may be made of a metal or alloy, for example the same material as the front module, in order to obtain sufficient strength for connecting to and holding the end of the tether and/or in order to obtain an increased mass for counteracting vibrations introduced while pushing and/or pulling the probe.

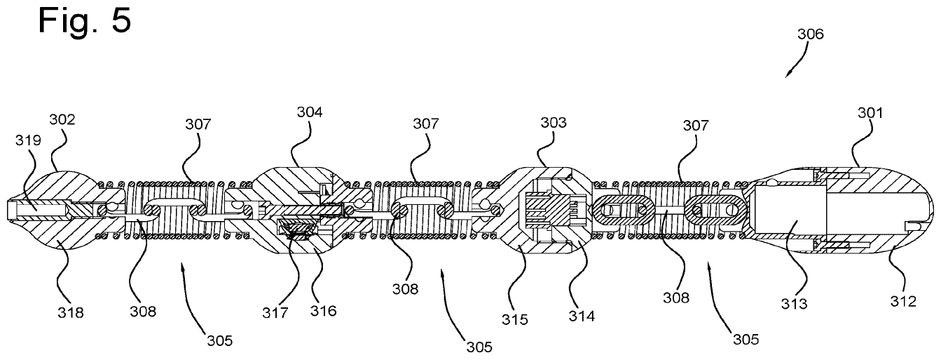

In the embodiment shown in FIGS. 3-5, the front module 301 contains the sensor payload. With respect to the embodiment of FIG. 2, the communication and power interface 315 for transferring the collected data to an external computer system and providing power for charging the battery is moved to a subsequent module 303. The interface 315 and the sensor payload (not shown) are interconnected via a cable (not shown) which may extend through the flexible connection 305. Placing the interface in a separate module may be done for at least one of the following reasons. The interface, which may be an interface for connecting a cable of a known type to a computer, may be a relatively bulky component with respect to the electronics of the sensor payload. So by moving the interface to the separate module 303, space can be saved in the interior volume inside the front module 301. In this way, for example, more space becomes available for the sensor payload, which may thus for example comprise more sensors. Alternatively, or in combination, moving the interface to the separate module 303 may be a means to reduce the overall diameter of the sensor probe and achieve a sensor probe which can be used in pipelines of smaller diameters.

Due to the compartmentalization of the sensor probes shown in the drawings, the overall outer diameter of the sensor probe can be reduced to 40 mm or smaller, preferably 35 mm or smaller such that the sensor probes are suitable for use in pipelines of 50 mm or larger. The inventors have developed a sensor probe according to the embodiment shown in FIGS. 3-5 with an outer diameter of 33 mm.

In the embodiment shown in FIGS. 3-5, likewise, a subsequent module 304 contains an electromagnetic field generator 317 for the purposes of locating the sensor probe 306 in combination with an external locating device. Likewise, the rear module 302 is provided for the connection to the driving mechanism and contains an opening 319 at the rear end of the probe for receiving an end of a tether such as a fiber rod.

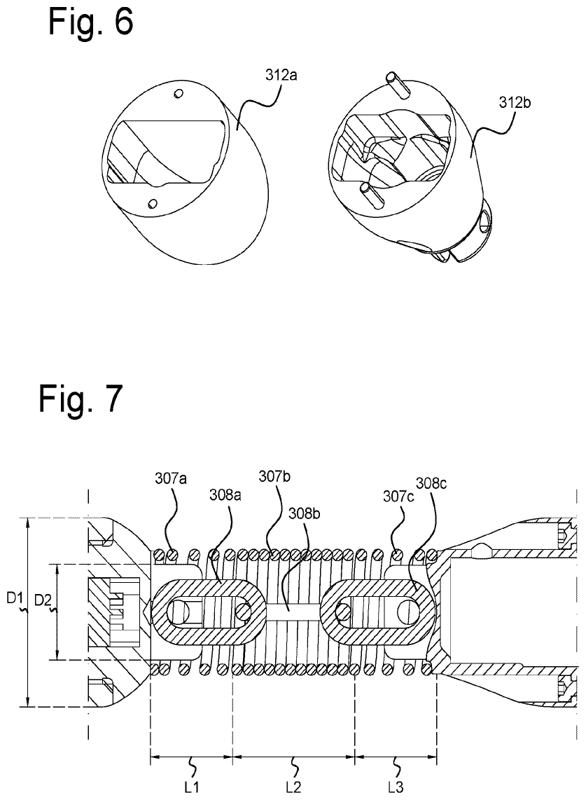

The housing 312 of the front module 301 is preferably made of a metal or an alloy, such as for example steel, in order to obtain an increased mass in view of keeping the sensor payload centered in the pipeline and/or counteracting vibrations introduced while pushing and/or pulling the probe, and in view of shielding the electronics of the sensor payload (not shown) from electromagnetic interference. As shown in the cross-section of FIG. 5 and the views of FIG. 6, the housing 312 may be composed of two parts which are fixed to each other by means of screws and which together form the interior volume 313 for holding the sensor payload (not shown). The mass of the housing 312 is preferably kept maximal, i.e. the interior volume is preferably minimized in such a way that it corresponds as closely as possible to the outer shape of the sensor payload. The front module 301 is preferably longer and heavier than the subsequent modules. All these measures may contribute to achieving an overall more central position of the sensor payload at the bottom of the pipeline during use and thus to an improved accuracy of the measurements.

The housing 314 of the subsequent module 303, which contains the communication and power interface 315, is preferably also made of the metal or alloy, i.e. the same material as the housing 312 of the front module. The housing 314 may comprise two parts which are screwed into each other, such that the interface may be revealed by unscrewing these two parts from each other. The interface is preferably a cable interface of a known type, configured for receiving a cable connector for connecting to a conventional computer system. In embodiments, the interface may also comprise a wireless communication interface for wireless transfer of the collected measurement data, such as for example a Bluetooth, wifi or other known wireless communication interface and/or a wireless charging interface.

The housing 316 of the subsequent module 304 which contains the electromagnetic field generator 317 is preferably made of a plastic material, or in general a material which does not block the electromagnetic field generated by the electromagnetic field generator 317.

The housing 318 of the rear module 302 may be made of a metal or alloy, for example the same material as the front module, in order to obtain sufficient strength for connecting to and holding the end of the tether and/or in order to obtain an increased mass for counteracting vibrations introduced while pushing and/or pulling the probe.

In embodiments, the sensor probe, preferably each of the modules 201-203, 301-304, has an aerodynamic shape for reducing interference with a fluid in the pipeline. This way, the sensor probes 206, 306 are suitable for use in live fluid pipelines, although they may also be used in other pipelines.

In the embodiments shown, the sensor probes 206, 306 are provided for use in combination with a driving mechanism comprising a tether, such as for example a fiber rod, for pushing the sensor probe through the pipeline infrastructure. An odometer may be incorporated into one of the modules of the sensor probe. Alternatively, the system may comprise an odometer in combination with the tether for recording a path travelled by the sensor probe as it is driven through the pipeline, preferably wherein the odometer is provided to record the length of the tether that passes along the odometer. Such an embodiment is shown in FIG. 1, where the tether 104 is pushed through external odometer 109 provided above the surface 101.

### Flexible Connection

In the embodiments shown, the sensor probes 206, 306 comprises flexible connections 205, 305 which connect the modules to each other. Each flexible connection comprises a spring 307, configured for at least straightening the sensor probe after a bend in the pipeline, and a flexible element 308 mounted on the inside of the spring, configured for bearing a predefined tensile load. In the embodiments shown, the tensile load-bearing flexible element are chains 308, preferably with a chain grade of at least 30. Chain grades are a standard method for showing the ultimate breaking strength (tensile strength) of a chain. Chain grades are determined by calculating newtons per square millimeter, using the formula “N/mm²”.

In embodiments, the tensile load-bearing flexible element(s) 308, or at least one of them, preferably have a tensile strength (minimum breaking strength) in a range between 0.3 kN and 1.5 kN, more preferably between 0.4 kN and 1.3 kN, more preferably between 0.5 kN and 1.0 kN. In embodiments, the tensile load-bearing flexible element(s), or at least one of them, may also be a rope or cable or the like, such as for example a twisted steel wire rope.

It has been found that connecting the modules by means of such a flexible connection, preferably comprising a spring 307 and a flexible element such as a chain 308 inside the spring, the flexibility of the sensor probe, in particular its capacity to take sharper turns and/or to be bent to a greater extent, can be enhanced while still ensuring that the sensor probe returns to its original, natural state after the bend in the pipeline and while still achieving a robust sensor probe capable of withstanding a predefined tensile load. Embodiments of the sensor probe 206, 306 according to the invention may be capable of taking a sharp 90° turn and, for example be entered into a live pipeline at a perpendicular angle through a live-fluid entry apparatus and make a 90° angle change of direction once inside the pipeline to align with the orientation of the pipeline, as schematically shown in FIG. 1. The tensile load-bearing capacity may be of particular importance when the sensor probe 206, 306 is to be pulled back through the pipeline infrastructure. The capability of straightening the sensor probe after each turn may have advantages in enhancing the accuracy of data collected by means of the sensor payload.

In the embodiments shown, the springs 307 are further configured for removing torsion from the sensor probe 206, 306. This means that the springs are connected to the respective modules in such a way that any torsion which occurs upon driving the sensor probe 206, 306 through the pipeline is counteracted by the springs. In other words, the relative roll of the modules with respect to each other is minimized or cancelled by the springs returning to their natural position. This is achieved by providing the springs 307 with bent front and rear ends 309, 310 which fit into corresponding notches provided in the respective modules in front of and behind the spring. The removal of any torsion from the sensor probe may have advantages in enhancing the accuracy of data collected by means of the sensor payload in the front module 201, 301.

In the embodiment shown, the springs are further configured for maintaining the chain 308 inside the spring at maximum length, i.e. “stretching” the chain 308 as far as possible by pushing the chain links 308a-c (see FIG. 7) outwards as far as they can. This means that the springs 307 may be held between the modules in their natural state, or in a slightly compressed state, in general preferably at least such that the spring force tends to stretch the chain to its maximum length. This may enhance the capability of straightening the sensor probe 206, 306 after each turn, which may have advantages in further enhancing the accuracy of data collected by means of the sensor payload.

As shown, the sensor probe 206, 306 is preferably generally circular in cross-section. The modules preferably all have substantially the same, first outer diameter D1 (see FIG. 7), which is the maximum diameter along the sensor probe. The first outer diameter may for example be in a range of 25 to 40 mm, preferably in a range of 30 to 35 mm. Each spring 307 preferably has a second outer diameter D2 with the second outer diameter being smaller than the first diameter, preferably between 50 and 90% of the first diameter D1, more preferably between 60 to 80% of the first diameter D1. Preferably, each of the modules has substantially the same, first, outer diameter D1 and each of the springs has substantially the same, second, outer diameter D2, although this is not essential. The smaller diameter D2 along the springs may have advantages in further enhancing the flexibility of the sensor probe 206, 306.

In the embodiments shown, the springs 307 have a plurality of coils 307a-c (see FIG. 7) wherein each spring has, its natural state, front and rear sections L1 and L3 where the coils 307a, 307c of the spring are spaced apart and a middle section L2 where the coils 307b lie against each other and are not spaced apart in the natural state. In this way, the front and rear sections L1, L3 of the spring can expand on the outside of a bend and contract on the inside of the bend, which may have advantages in further enhancing the flexibility of the sensor probe. The coils in the middle section L2 are preferably not spaced apart to avoid that the probe is hindered by a possible obstruction when taking a turn, for example a ridge of a live-fluid entry apparatus 108. Preferably, the front and rear sections L1, L3 comprise at least two, more preferably at least four coils or windings 307a, 307c. Preferably, the number of coils in the middle section L2 is higher than the number of coils of each of the front and rear sections L1, L3. Preferably, the middle section L2 comprises at least four, more preferably at least eight coils 308b.

In embodiments, the chains 308 may have at least three, preferably at least four pivot points and/or at least two, preferably at least three complete chain links 308a-c, in order to achieve an improved flexibility of the sensor probe 206, 306 and/or ensure its capacity of taking a sharp 90° turn.

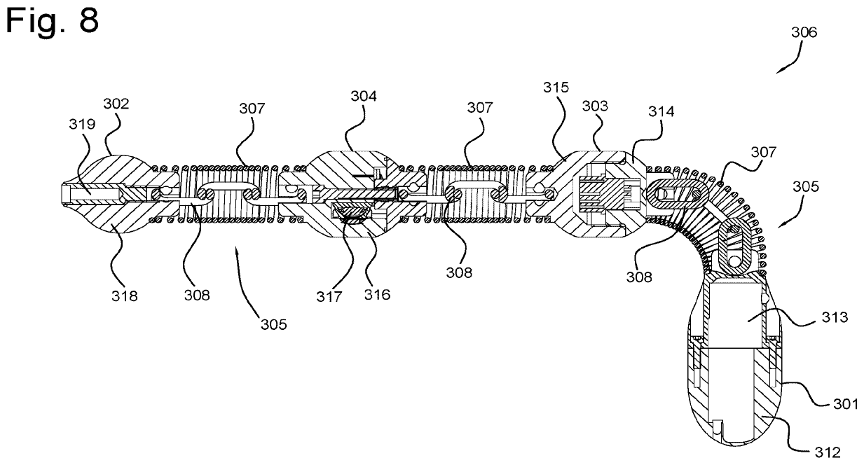

FIG. 8 shows a cross-sectional view of the probe 306 of FIGS. 3-5 when taking a 90° turn.

### Improved Roll Compensation

In embodiments, such as the probes 206, 306 shown in the drawings, the first module 201, 301 containing the sensor payload, or generally the front module, may be larger and heavier than the subsequent modules of the train. For example, the front module 201, 301 may have an oblong shape while the subsequent modules 202-203, 302-304 may have a more spherical shape. In this way, it may be achieved that the first or front module 201, 301 remains in a more central position on the bottom of the pipeline with respect to the other modules, i.e. better follows the bottom curve of the pipeline. In other words, it may be achieved that the sensor probe 206, 306 better follows the shape of the pipeline through which it is driven. This may increase the accuracy of the data collected by means of the sensor probe, because the roll, heading and/or pitch values measured by means of the sensor payload are obtained from a more central measurement position in the pipeline, and less compensation or post-processing corrections may be needed in order to obtain the trajectory of the pipeline with sufficient accuracy.

For example, in embodiments where the sensor probe 206, 306 is pushed and/or pulled through the pipeline by means of a tether of the driving mechanism, such as a fiber rod, the tether may cause the sensor probe to roll as it is pushed through the pipeline. The roll value of the sensor probe may be recorded by means of the one or more sensors of the sensor payload (as described above) in the first module 201, 301. In combination with the first module being larger and heavier than the subsequent modules of the train, such that the first module remains in a more central position on the bottom of the pipeline with respect to the other modules, this may increase the accuracy of the roll samples collected by means of the sensor probe, especially because the roll samples are each time obtained from a more central measurement position in the pipeline.

### Measurement Method

In the following, embodiments of methods for mapping and/or inspecting an underground pipeline infrastructure using for example the sensor probes 206, 306 will be described. In general, the method comprises: entering the sensor probe 206, 306 into a pipeline of the pipeline infrastructure, driving the sensor probe through the pipeline by means of a driving mechanism 105, such as by means of the tether 104, and collecting geospatial data by means of the sensor probe while it travels through the pipeline 107.

In embodiments, the sensor probe 206, 306 may be pushed and/or pulled through the pipeline by means of a tether 104 of the driving mechanism, such as for example a fiber rod, wherein the tether causes the sensor probe 206, 306 to roll as it is pushed through the pipeline, and wherein a roll value of the sensor probe is recorded by means of the sensor payload in the first or front module 201, 301.

In embodiments, the first module 201, 301 may be larger and heavier than the subsequent modules of the train, such that the first module remains in a more central position on the bottom of the pipeline with respect to the other modules. This may increase the accuracy of the data collected by means of the sensor probe, especially in combination with the measurement or determination of the roll value by means of one or more sensors of the sensor payload.

In embodiments, the method may further comprise recording a path travelled by the sensor probe 206, 306 as it is driven through the pipeline by means of an odometer, preferably wherein the odometer 109 is external to the sensor probe and records the length of the tether 104 that passes along the odometer.

In embodiments, the method may further comprise determining at least one location coordinate, such as a start-point coordinate, an end-point coordinate and/or a guide-point coordinate of the sensor probe 206, 306 by means of an electromagnetic field generator provided in one of the modules of the sensor probe in combination with an external locating device (not shown). Such a point coordinate can be obtained by positioning the sensor probe at the relevant position, i.e. the start position, end position or waypoint position, and positioning the external locating device above ground and detecting the minimum distance to the sensor probe, i.e. the depth of the sensor probe with respect to the external locating device. This depth can be detected by means of the electromagnetic field generator 317 as described herein. The position of the locating device above ground can be detected by using GPS coordinates or the like. This, in combination with the detected depth of the sensor probe, gives coordinates of the start position, end position or waypoint position.

In embodiments, the sensor probe 206, 306 may be used to collect the geospatial data in at least one of a forwards travelling direction (wherein the sensor probe is for example pushed by means of the tether) and a backwards travelling direction (wherein the sensor probe is for example pulled back by means of the tether). The combination of both directions may be used to increase the accuracy of the measurement, for example by averaging in a post-processing method.

In embodiments, the measurement data obtained by means of the sensor payload may be stored in a memory on board the sensor probe 206, 306 and transferred into a computer system after retrieval of the sensor probe from the pipeline infrastructure. In other embodiments, the data may be transferred real-time, for example by means of communication via a tether which allows communication between the sensor probe and a computer system. A real-time or post-processing software may be used to merge geospatial data collected by means of the sensor probe, as described herein, a path travelled by the sensor probe recorded by means of an odometer (external or on-board), and at least one location coordinate determined by means of the sensor probe in combination with an external locating device.

Embodiments of the systems and methods for mapping and/or inspecting an underground pipeline infrastructure may comprise at least one of the following features.

The sensor probe 206, 306 may be provided to enter the pipeline, such as a live fluid pipeline 107, at a perpendicular angle through a live-fluid entry apparatus 108 and once inside the pipeline make a 90° angle change of direction to align with the orientation of the pipeline.

The live-fluid entry apparatus may comprise a guide shoe 103 configured to be perpendicularly inserted into an opening in the pipeline, in particular inserted into the pipeline through the live-fluid entry apparatus, and to guide the sensor probe upon entry into the pipeline.

The sensor probe 206, 306 may be sized and compartmentalized, i.e. subdivided into the modules, for passing through the guide shoe and make the 90° angle change of direction.

The sensor probe may be configured to access pipelines at least 50 mm in diameter, without interfering with a fluid in the pipeline, i.e. still allowing sufficient passage of the fluid while conducting the measurement.

The method may comprise coordinating pipeline features, such as for example known or otherwise measured bends or waypoints, with x-, y-, and z-axis location data obtained by the sensor probe.

The sensor probe may comprise an inertial navigation sensor payload that is provided to collect x, y, and z geospatial data in at least one of a forwards travelling direction and a backwards travelling direction.

1. A system for mapping and/or inspecting an underground pipeline infrastructure, comprising:
a sensor probe for collecting geospatial data while travelling through a pipeline of the pipeline infrastructure, and
a driving mechanism for driving the sensor probe, wherein the sensor probe comprises a train of at least two modules of which a first module contains a sensor payload for collecting said geospatial data and a second module is provided for connecting the sensor probe to the driving mechanism, wherein each two successive modules of said train are connected to each other by means of a flexible connection which allows the sensor probe to travel through pipeline bends, wherein each flexible connection comprises a spring configured for straightening the sensor probe after travelling through pipeline bends and a flexible element mounted on the inside of the spring configured for bearing tensile loads.

2. The system according to claim 1, wherein each spring is further configured for removing torsion from the sensor probe and/or maintaining the flexible element inside the spring at maximum length.

3. The system according to claim 1, wherein the sensor probe has a first outer diameter and each spring has a second outer diameter, the second outer diameter being smaller than the first diameter, preferably between 50 and 90% of the first diameter, more preferably between 60 to 80% of the first diameter.

4. The system according to claim 3, wherein the first outer diameter is in a range of 25 to 40 mm, preferably in a range of 30 to 35 mm.

5. The system according to claim 1, wherein each spring has, in its natural state, front and rear sections wherein coils of the spring are spaced apart and a middle section wherein the coils lie against each other.

6. The system according to claim 1, wherein each spring has bent front and rear ends which fit into notches provided in the respective modules in front of and behind the spring.

7. The system according to claim 1, wherein the flexible element has a tensile strength in a range between 0.3 kN and 1.5 kN, more preferably between 0.4 kN and 1.3 kN, more preferably between 0.5 kN and 1.0 kN.

8. The system according to claim 1, wherein the flexible element is a chain, preferably with a chain grade of at least 30.

9. The system according to claim 8, wherein the chain has at least three, preferably at least four pivot points.

10. The system according to claim 8, wherein the chain has at least two, preferably at least three complete chain links.

11. The system according to claim 1, wherein the train of modules comprises at least one of the following modules: a third module containing a communication and/or power interface for transferring the collected data to an external computer system and/or for charging a battery of the probe, a fourth module containing an electromagnetic field generator for locating the sensor probe in combination with an external locating device and thereby determining at least one location coordinate, a fifth module comprising a visual inspection device such as a camera, a sixth module comprising an odometer for recording a path travelled by the sensor probe as it is driven through the pipeline, a seventh module comprising at least one environment sensor for measuring for example pressure, temperature, humidity or another environment parameter.

12. The system according to claim 1, wherein sensor probe, preferably each of the modules, has an aerodynamic shape for reducing interference with a fluid in the pipeline.

13. The system according to claim 1, wherein the first module containing the sensor payload is the front module of the train and wherein the second module provided for connecting the sensor probe to the driving mechanism is the rear module of the train.

14. The system according to claim 13, wherein the driving mechanism comprises a tether, such as for example a fiber rod, for pushing the sensor probe through the pipeline infrastructure, preferably wherein the system further comprises an odometer in combination with the tether for recording a path travelled by the sensor probe as it is driven through the pipeline, preferably wherein the odometer is provided to record the length of the tether that passes along the odometer.

15. The system according to claim 1, wherein the first module is larger and/or heavier than the subsequent modules of the train.

16. The system according to claim 1, wherein the sensor payload in the first module is provided for recording a roll value as the sensor probe travels through the pipeline.

17. A method for mapping and/or inspecting an underground pipeline infrastructure, comprising:
entering a sensor probe into a pipeline of the pipeline infrastructure,
driving the sensor probe through the pipeline by means of a driving mechanism, and collecting geospatial data by means of the sensor probe while it travels through the pipeline;
wherein the sensor probe comprises a train of at least two modules of which a first module contains a sensor payload for collecting said geospatial data and a second module connects the sensor probe to the driving mechanism,
wherein each two successive modules of said train are connected to each other by means of a flexible connection which allows the sensor probe to travel through pipeline bends, and
wherein each flexible connection comprises a spring that straightens the sensor probe after travelling through pipeline bends and a flexible element that bears tensile loads and is mounted on the inside of the spring.

18. The method according to claim 17, wherein the sensor probe is pushed through the pipeline by means of a tether of the driving mechanism, such as for example a fiber rod, wherein the tether causes the sensor probe to roll as it is pushed through the pipeline, and wherein a roll value of the sensor probe is recorded by means of the sensor payload in the first module.

19. The method according to claim 17, wherein the first module is larger and heavier than the subsequent modules of the train, such that the first module remains in a more central position on the bottom of the pipeline with respect to the other modules.

20. The method according to claim 17, further comprising recording a path travelled by the sensor probe as it is driven through the pipeline, by means of an odometer, preferably wherein the odometer is external to the sensor probe and records the length of the tether that passes along the odometer.

21. The method according to claim 17, further comprising determining at least one location coordinate, such as a start-point coordinate, an end-point coordinate and/or a guide-point coordinate of the sensor probe by means of an electromagnetic field generator provided in one of the modules of the sensor probe in combination with an above ground locating device.

22. The method according to claim 17, wherein a real-time or post-processing software is used to merge the geospatial data collected by means of the sensor probe, a path travelled by the sensor probe recorded by means of an odometer, and at least one location coordinate determined by means of the sensor probe in combination with an external locating device.

23. The method according to claim 17, wherein the sensor probe is used to collect the geospatial data in at least one of a forwards travelling direction and a backwards travelling direction.

24. A non-transitory storage medium storing a real-time or post-processing software which is configured to, when executed on a computer system, merge geospatial data collected by means of the sensor probe as defined in claim 1, a path travelled by the sensor probe recorded by means of an odometer, and at least one location coordinate determined by means of the sensor probe in combination with an external locating device.
